(19) United States
(12) Patent Application Publication
(10) Pub. No.: US 2007/0048701 A1
(43) Pub. Date: Mar. 1, 2007

(54) Math aid

(76) Inventor: Scott Fields, Blackfoot, ID (US)

Correspondence Address: ROBERT L. SHAVER;DYKAS, SHAVER & NIPPER, LLP, PO BOX 877, BOISE, ID, 83701-0877, US

(21) Appl. No.: 11/219,080

(22) Filed: Sep. 1, 2005

(51) Int. Cl. G09B 23/02; G09B 19/02

(52) U.S. Cl. 434/188

(57) ABSTRACT

A math teaching aid for helping beginning students learn how to count change. The invention includes a number of base units with cylindrical depressions in slots for a flag. A flag which determines the desired amount of change is placed in a flag holder in the base unit. Units representing pennies, nickels, dimes and quarters are then placed in the grooves of the base unit to arrive at the desired amount of change.

### BACKGROUND OF THE INVENTION

1. Field of the Invention

The present invention is directed to a math teaching aid, and more specifically to an aid for learning about and practicing counting of coins to make change.

2. Background Information

There are a number of aids for teaching beginning counters how to use coins to make change. These include the use of boards and other traditional tools. These require the interaction of a teacher to draw problems on the board, and then require a student to respond by answering a question or drawing on the board. This kind of method works fine for many students, but for some students the chalkboard method is not as easily understandable as it could be. For some students a very three dimensional and tactile approach is more effective. If students can see something and lift a solid piece that has form, color, weight and tactile as well as visual feedback, they learn a concept more quickly.

Something which is also needed is a method which is flexible enough that a wide variety of problems can be presented, and a system in which the student can work on problems without continual involvement of a teacher.

These and other goals are satisfied by the math teaching aid of the invention.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

These and other goals are accomplished by the math teaching aid of the invention. The math teaching aid of the invention includes a number of parts, starting with one or more base units. The base unit is a piece which can be two dimensional or three dimensional, and which has a number of semi-circular depressions or concavities. These are made to fit with other pieces which have semi-circular protrusions or bulges which interfit with the concavities of the base units. The base units also have a number of flag holders which are positioned between the semi-circular depressions.

Another piece which is part of the math teaching aid of the invention is one or more penny representations. The penny representation is a generally circular penny body, which interfits with the concavities of the base units. The invention also includes one or more nickel representations, with each nickel representation being made of a nickel body with five semi-circular protrusions or convexities, which are made to interfit with the base unit depressions. The math teaching aid of the invention also includes one or more dime representations, which are made up of a dime body with ten semi-circular protrusions or convexities, which interfit with the base unit depressions. The invention also includes one or more flags, for placement in one of the flag holders of the base unit. The flag represents a chosen numerical value on the base unit, and a student uses the pieces of the math teaching aid to assemble a combination of coin representations to fulfill the chosen numerical value.

An example of how this would be used is when an instructor selects a flag for nine cents. The flag indicating nine cents is placed in a flag holder, and the student is instructed to assemble the right combination of coin representations to fulfill the nine cent goal. To do this, the student can use one nickel representation, plus four penny representations. Alternatively, he could use nine penny representations. He could try to use a dime representation, but the game would demonstrate to the student that the dime is too big to fulfill the goal of nine cents. By the use of more coin representations, such as quarter representations and the use of multiple base units so that a larger number can be fulfilled, such as one dollar, the game can be utilized to teach a student how to make change for a dollar. If base units were assembled which had one hundred concavities, representing the possibility of filling those concavities with one hundred penny representations, the student could discover that four quarters would fill all of the one-hundred slots. Alternatively, twenty of the nickel representations would fill the available one hundred slots; and ten of the dime representations would fill the one-hundred slots that are available.

The flags in the game can have specific numbers in dollars and cents written on them, or they could have a surface which is available for writing the selected numerical value. They would also have a representation of a particular denomination of coin.

One version of the math teaching aid is one in which the pieces are three dimensional. In this version of the teaching aid, the base units are generally rectangular, and have a bottom surface and a top surface. The top surface is inscribed with a number of semi-cylindrical depressions or concavities. The base units can be of various sizes, such as to accommodate ten pennies, twenty-five pennies, or other sizes. They can be linkable together; so that three base units can be assembled to provide the possibility of slots for thirty pennies.

In the three dimensional game, the penny representations would typically be cylindrical in form, and be made to interfit with the semi-cylindrical concavities in the top surface of the three dimensional base unit. The nickel representation as well as a dime and quarter representation, would also be generally rectangular with a top surface and a bottom surface and for the nickel representation, would have five semi-cylindrical convex protrusions formed in the bottom surface, which interfit with the concave depressions in the top surface of the base units. The dime representation would thus have ten cylindrical convexities, and the quarter representation would have twenty-five cylindrical convexities in their respective bottom surfaces. The coin representations of the penny, nickel, dime and quarter could also have an image of a penny formed on the side of each of the cylinders, or semi-cylindrical convexities. These would reinforce the idea that each of these cylinders or convexities represented a penny, and when a person had assembled fourteen pennies worth of cylinders, that would be equal to fourteen pennies. Each of the penny cylinders, as well as the coin representations, may also include a lifting handle which is in the form of a representation of the coin for that block. For instance, each of the penny cylinders could have a penny lifting handle for moving the penny cylinder into place. The nickel representation would have a representation of a nickel on top of the top surface, which would serve as a lifting handle for the nickel representation. Similarly, the dime and quarter representations could have a representation of a dime or quarter serving as a lifting handle to lift the entire piece into place.

A set of example instructions follows which could direct an instructor in using the teaching aid of the invention:

DIRECTIONS—Remember you know your students. Let them discover the “what works, when it works, why it works, and how it works” answers to your money questions. Students must show Carmen a correct answer and learn why she doesn't let them make a wrong answer.

Step 1. Determine the maximum amount of coin value you want to work with from 1 cent to 10 cents to 25 cents. Use the 1-12 base for lower values or both bases depending on student skill level.

Step 2. Place the base(s) with the slots on top on a flat surface. Best if the student views and counts from left to right. If both bases are used, place in one continuous line from left to right.

Step 3. Choose a Carmen stopper amount (from 1 to 25 cents). Place the Carmen stopper, with the value facing one, in the corresponding slot. A trained peer may also place the Carmen stoppers too. The stoppers may be mixed up to provide practice as needed.

Step 4. Place a handful of penny cylinders and corresponding nickel and/or dime cylinder blocks on the surface.

START ASKING THE STUDENT QUESTIONS. Your goal is to have the student fill each slot to the Carmen stopper and provide you with critical thinking answers where applicable. Carmen can help you:

ASK about Coin recognition and value. Show me a nickel. How much is a nickel worth? How many pennies are in one nickel? And what about that troublesome question, “Why is a dime worth more than a nickel?” Hint—They may detect a weight difference.

ASK about Coin combinations. What coins can you use to make [1-25 cents]? What other coins can you use [for the specified amount]? Show me another way to make [the specified amount]. Why can't you use two dimes to make a teen amount?

ASK about Item purchases. If you have _ cents and the item costs _ cents, how much more money do you need to buy it? Do you have enough money to buy it? If the item costs _ cents, show coin combinations that you need to buy it? Show me another combination.

ASK about Counting chance back. If you have _ cents and the item costs _ cents, how much money will you get back?

Note—Although primarily a monetary teaching tool, the Carmens may also be used to practice sequential ordering; one-to-one correspondence counting; number recognition and even/odd counting.

Encourage the best in your students. ASK them to try. Let them discover money.

The purpose of the foregoing Abstract is to enable the United States Patent and Trademark Office and the public generally, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is a perspective view of several of the components of the math teaching aid, including a base unit, a nickel representation and two penny representations.

FIG. 2 is a perspective view of the math teaching aid which has been assembled to fulfill a seven cent goal.

FIG. 3 is a perspective view of a dime representation for use in the invention.

FIG. 4 is a perspective view of a quarter representation for use in the invention.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

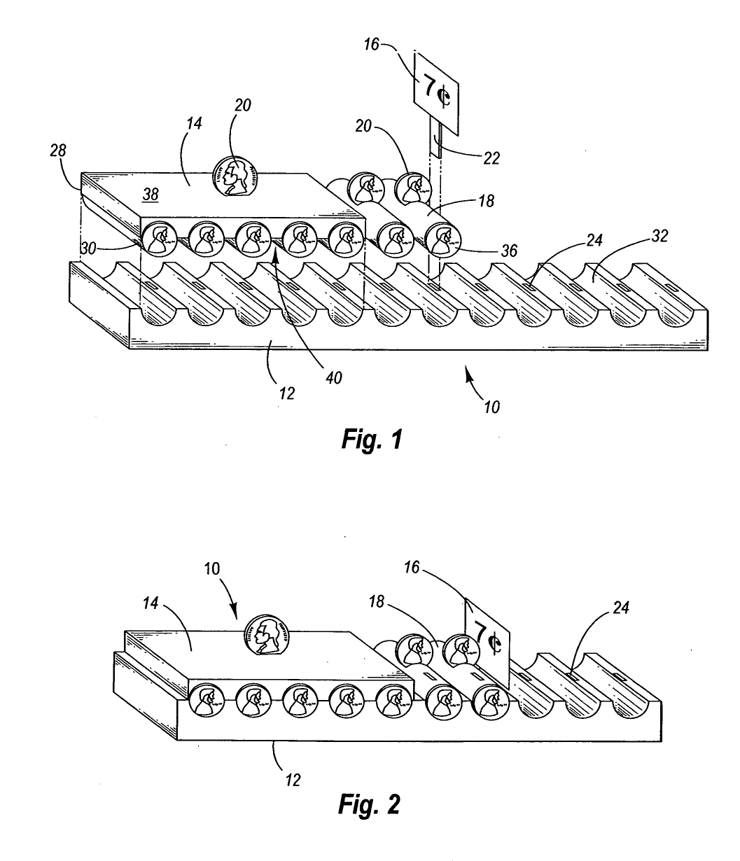

The preferred embodiment of the invention is shown in FIGS. 1-4. FIG. 1 shows several components of the invention in a preferred embodiment. In this embodiment, the base unit is approximately 12 inches long, 1.5 inches wide and 0.5 inches tall. The base unit 12 which is shown in FIG. 1 includes a number of semi-cylindrical concavities 32, in this case numbering twelve. Base units can have any number of concavities 32, such as 10, 25, or 35. Base units can be assembled end to end in order to better illustrate a particular number, or they can be assembled side by side for different representation of a number goal to be fulfilled. The base unit 12 can be made of wood, plastic, metal or other suitable material. The flag or stopper 16 can take a number of configurations, one configuration is one in which the flag 16 includes a tab 22 which fits in a slot 24 in the base unit 12. The flag 16 can have a specified numerical value, such as seven cents as shown. It can also have a surface which can be written on, and may optionally be an erasable surface, so that one flag or stopper can be utilized in a number of different exercises for different numerical values.

FIG. 1 also shows two one cent or penny representations 18, which in this case are cylindrical in form, and which have a penny image 36 or a representation on the end, so that when the penny marker is placed in a slot 32 of the base unit, it clearly represents one penny when counting. The penny marker 18 has a marker handle 20, which is in the form of an image or representation of a penny. This just reinforces that the value of this unit is equal to one penny in this exercise.

FIG. 1 also includes a nickel or five cent unit 14. The nickel or five cent unit includes a nickel body 28, a nickel top surface 38, and a nickel bottom surface 40. From the nickel bottom surface 40 a number of semi-cylindrical convexities 30 protrude from the nickel marker 14. These convexities or bulges, are designed to interfit with the concavities 32 of the base unit.

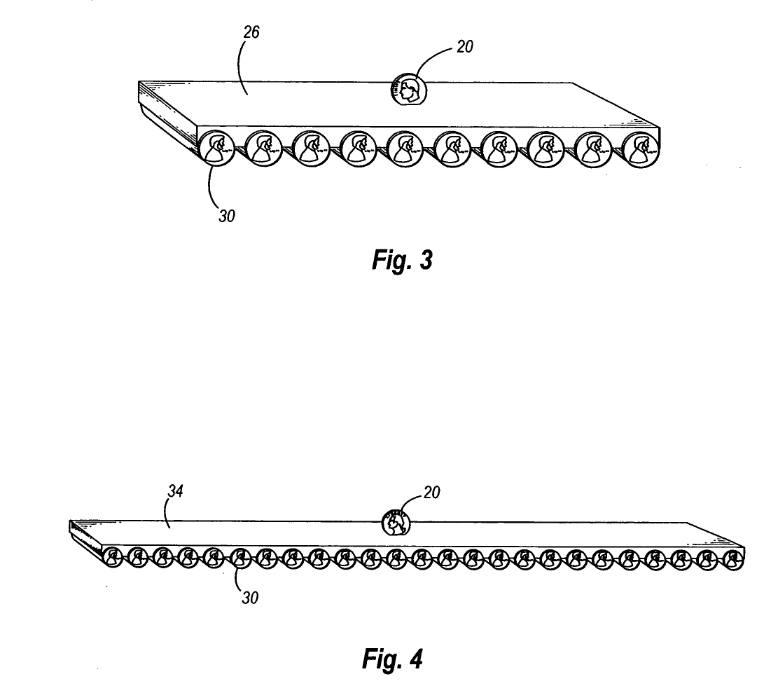

The unit shown in FIG. 2 works in the following manner. A teacher or student selects a flag 16 for a chosen numerical value. If the flag is a rewriteable flag, the student or teacher may write in a number, such as seven cents. The teacher or the student then places the flag marked for seven cents in the appropriate seven cent slot 24 on the base unit 12. The student then assembles the appropriate units in order to fill every groove or concavity 32 to one side, preferably the left side of the flag 16. Thus, to fulfill a seven cent goal, the student could use one nickel marker 14, and two penny markers 18. Other combinations are also possible, such as seven penny markers 18, as well as the use of other markers such as a dime marker 26 which is shown in FIG. 3. Multiple base units 12 can be used, and base units 12 can have more than the ten depressions 32 showing in FIG. 2, which is used merely as an example.

FIG. 3 shows a dime or ten cent unit 26, which could also be utilized in the game.

FIG. 4 shows a quarter or twenty-five cent unit 34, which could also be utilized in the game. Each of the coin representations also can include a marker handle 20, which is preferably a physical representation of the coin represented. Thus a nickel marker 14 would have an image of a coin as its handle 20. The quarter unit 34 shown in FIG. 4 would have an image of a quarter as its marker handle 20. Each of the coin representations preferably has an image of a penny positioned on the end of the cylinder of the convexity. This further reinforces the understanding of the student that each of these markers represent the visible number of pennies.

The game could also be made in a two dimensional format, with similar concavities and convexities, and markers and game strategy.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

I claim:

1. A math teaching aid comprising:
one or more base units, with said base units having a plurality of semicircular concavities for interfitting relationship with other pieces, with said base unit further comprising a plurality of flag holders;
one or more penny representations, comprising a generally circular penny body for interfitting relationship with said base unit concavities;
one or more nickel representations, comprising a nickel body with five semicircular convexities for interfitting relationship with said base unit concavities;
one or more dime representations, comprising a dime body with ten semicircular convexities for interfitting relationship with said base unit concavities;
one or more flags, for placement on one of said flag holders of said base units; wherein
said flag placement represents a chosen numerical value on said base unit, and a student may assemble a combination of representations to fulfill said numerical value.

2. The math teaching aid of claim 1 in which said flags include specific numbers in dollars and cents on them.

3. The math teaching aid of claim 1, in which said one of more base units are generally rectangular, with a bottom surface and a top surface, with said semicircular concavities being generally semi-cylindrical and formed in said top surface of said base units.

4. The math teaching aid of claim 2, in which said one of more penny representations are generally cylindrical, and interfit with said semicircular concavities in said top surface of said base units.

5. The math teaching aid of claim 2, in which said one of more nickel representations are generally rectangular with a top surface and a bottom surface, with five cylindrical convexities formed in said bottom surface, with said convexities interfitting with said semicircular concavities in said top surface of said base units.

6. The math teaching aid of claim 2, in which said one of more dime representations are generally rectangular with a top surface and a bottom surface, with ten cylindrical convexities formed in said bottom surface, with said convexities interfitting with said semicircular concavities in said top surface of said base units.

7. The math teaching aid of claim 2, which further includes one or more quarter representations, which are generally rectangular with a top surface and a bottom surface, with twenty five cylindrical convexities formed in said bottom surface, with said convexities interfitting with said semicircular concavities in said top surface of said base units.

8. The math teaching aid of claim 3, in which said penny representations include an image of a penny on at least one end of said cylinders.

9. The math teaching aid of claim 3, in which said penny representations include a coin shaped representation of a penny attached to said cylinders, which serves as a lifting handle.

10. The math teaching aid of claim 4, in which said nickel representations include images of pennies on said convexities.

11. The math teaching aid of claim 4, in which said nickel representations include a coin shaped representation of a nickel attached to said generally rectangular nickel representation, which serves as a lifting handle.

12. The math teaching aid of claim 5, in which said dime representations include images of pennies on said convexities.

13. The math teaching aid of claim 5, in which said dime representations include a coin shaped representation of a dime attached to said generally rectangular dime representation, which serves as a lifting handle.

14. The math teaching aid of claim 6, in which said quarter representations include images of pennies on said convexities.

15. The math teaching aid of claim 6, in which said quarter representations include a coin shaped representation of a quarter attached to said generally rectangular quarter representation, which serves as a lifting handle.

16. A math teaching aid comprising:
one or more generally rectangular base units, with a bottom surface and a top surface, and with semicircular concavities formed in said top surface for interfitting relationship with other pieces, with said base unit further comprising a plurality of flag holders;
one or more generally cylindrical penny representations, for interfitting with said semicircular concavities in said top surface of said base units;
one or more generally rectangular nickel representations, with a top surface and a bottom surface, with five cylindrical convexities formed in said bottom surface, with said convexities interfitting with said semicircular concavities in said top surface of said base units;
one or more dime representations, with each dime representation including a generally rectangular dime body with a top surface and a bottom surface, with ten cylindrical convexities formed in said bottom surface, with said convexities interfitting with said semicircular concavities in said top surface of said base units;
one or more flags, for placement on one of said flag holders of said base units, with the flags for marking a selected number of cents and dollars; wherein
said flag placement represents a chosen numerical value on said base unit and is placed in the corresponding flag holder of the base unit occupies, and a student may assemble a combination of representations to fulfill said numerical value.

17. The math teaching aid of claim 15 in which said penny, nickel and dime representations further include a representation of at least one penny on said convexities.

18. The math teaching aid of claim 15 in which said penny, nickel, and dime representations further comprise a coin shaped handle for lifting said penny nickel and dime representations.

19. The math teaching aid of claim 2 in which said flag holders are slots in the base units between each concavity.

20. The math teaching aid of claim 18 in which said flags further comprise a tab which fits in a selected slot in said base unit.

21. The math teaching aid of claim 2 in which each flag is marked with a specific numerical value.
